(19) United States
(12) Patent Application Publication
(10) Pub. No.: US 2011/0303344 A1
(43) Pub. Date: Dec. 15, 2011

(54) TEMPORARY TATTOO REMOVAL DEVICE AND METHOD FOR MAKING THE SAME

(76) Inventors: Doreen M.P. Bortel, Brooklyn Park, MN (US); Christopher James Uecker, Minnetonka, MN (US)

(21) Appl. No.: 13/159,012

(22) Filed: Jun. 13, 2011

Related U.S. Application Data
(60) Provisional application No. 61/353,757, filed on Jun. 11, 2010.

(51) Int. Cl. B65D 69/00; B32B 38/10; B44C 1/17; C09J 7/02; B44F 9/00

(52) U.S. Cl. 156/64; 428/41.8; 428/41.7; 428/41.6; 206/570

(57) ABSTRACT

Temporary tattoo removal devices for temporarily covering and concealing tattoos include an opaque tattoo removal device or a releasable coating layer that is configured to adhere to a user's skin to cover and conceal tattoos. The color of the opaque tattoo removal device or releasable coating layer matches the skin tone of the user's such that the tattoo removal device or releasable coating layer is nearly invisible when applied.

### FIELD

This disclosure relates generally to a temporary concealing or covering device, and particularly, but not by way of limitation, to devices and methods for temporarily concealing or covering tattoos, skin lesions, scars or other marks on a user's skin.

### BACKGROUND

Tattoos have been used in various cultural and social circles for many years. A tattoo is typically applied to an individual's skin with tattoo needles, which ink a desired design onto the skin. Now tattoo applications have become a common trend among young adults for self expression and an avenue for individuality.

Tattoos are fun and personally significant to the individual up until they interfere with other aspects of the individual's life, for example, an executive's “corporate” image, a dress code for an upscale restaurant or resort, or a special day for a bride.

Therefore, there is a need for a device to be applied to the individual's skin to temporarily conceal and disguise the tattoos or other marks.

### SUMMARY

Temporary tattoo removal devices for temporarily covering and concealing tattoos, skin lesions, scars or other marks and methods for making the same are disclosed herein. The temporary tattoo removal device includes an opaque tattoo removal device or a releasable coating layer that is configured to adhere to a user's skin to cover and conceal tattoos, skin lesions, scars or other marks. The color of the opaque tattoo removal device or releasable coating layer matches the skin tone of the user's such that the tattoo removal device or releasable coating layer is nearly invisible when applied.

A method for removing a tattoo includes comparing a desired skin tone with a plurality of colors available for a tattoo removal device; selecting a matching color from the plurality of colors available for the tattoo removal device; selecting a style of the tattoo removal device based on a shape of the tattoo to be covered; determining a dimension of the tattoo removal device based on a size of the tattoo to be covered; obtaining the tattoo removal device with the selected color, style and dimension, the tattoo removal device being at least partially opaque; removing a protective cover sheet to expose a base portion including a backing layer and an adhesive layer; overlaying the tattoo with the tattoo removal device to conceal the tattoo, with the adhesive layer positioned to contact user's skin, such that the base portion is substantially indistinguishable from the user's skin; and applying pressure on the base portion toward the user's skin at a location corresponding to the adhesive layer such that the base portion adheres to the user's skin.

A tattoo removal device includes a base portion including an opaque backing layer, the backing layer having a first major surface and a second major surface, the base portion further including an adhesive layer attached to the first major surface of the backing layer; and a protective coversheet, wherein the base portion is substantially indistinguishable from a desired skin tone.

A tattoo removal device kit includes a plurality of tattoo removal devices, each including a base portion including an opaque backing layer, the backing layer having a first major surface and a second major surface, the base portion further including an adhesive layer attached to the first major surface of the backing layer; and a protective coversheet, wherein the base portion is substantially indistinguishable from a desired skin tone. The tattoo removal device kit further includes instructions for use of the tattoo removal devices; and a packaging for containing the plurality of tattoo removal devices and the protective cover sheet, wherein styles of the tattoo removal devices include at least one selected from the group consisting of a circular patch, an elliptical patch, a square patch, a rectangular patch, a lower back patch, an irregularly-shaped patch and a tape.

This Summary is an overview of some of the teachings of the present application and not intended to be an exclusive or exhaustive description of the claimed invention. Further details about the present subject matter are found in the detailed description and appended claims. Other aspects of the subject matter will be apparent to persons skilled in the art upon reading and understanding the following detailed description and viewing the drawings that form a part thereof, each of which are not to be taken in a limiting sense. The scope of the claimed invention is defined by the appended claims and their equivalents.

### DESCRIPTION OF THE DRAWINGS

The drawings, which are not necessarily drawn to scale, illustrate generally, by way of example, but not by way of limitation, various embodiments discussed in this application.

FIG. 1 illustrates an exploded front perspective view of a tattoo removal device.

FIG. 2 illustrates an exploded cross-section view of one embodiment of the tattoo removal device.

FIG. 3 illustrates an exploded cross-sectional view of another embodiment of the tattoo removal device.

FIG. 4 illustrates an exploded cross-sectional view of a further embodiment of the tattoo removal device.

FIG. 5 illustrates a kit constructed in accordance with the principles of the present disclosure.

### DETAILED DESCRIPTION

In the following detailed description, reference is made to the accompanying drawings which form a part thereof, and in which is shown by way of illustration specific embodiments in which the inventive concepts may be practiced. These embodiments are described in sufficient detail to enable those skilled in the art to practice the invention, and it is to be understood that the embodiments may be combined or used separately, or that other embodiments may be utilized and that structural and procedural changes may be made without departing from the spirit and scope of the inventive concepts. The following detailed description provides examples, and the scope of the present invention is defined by the claims to be added and their equivalents.

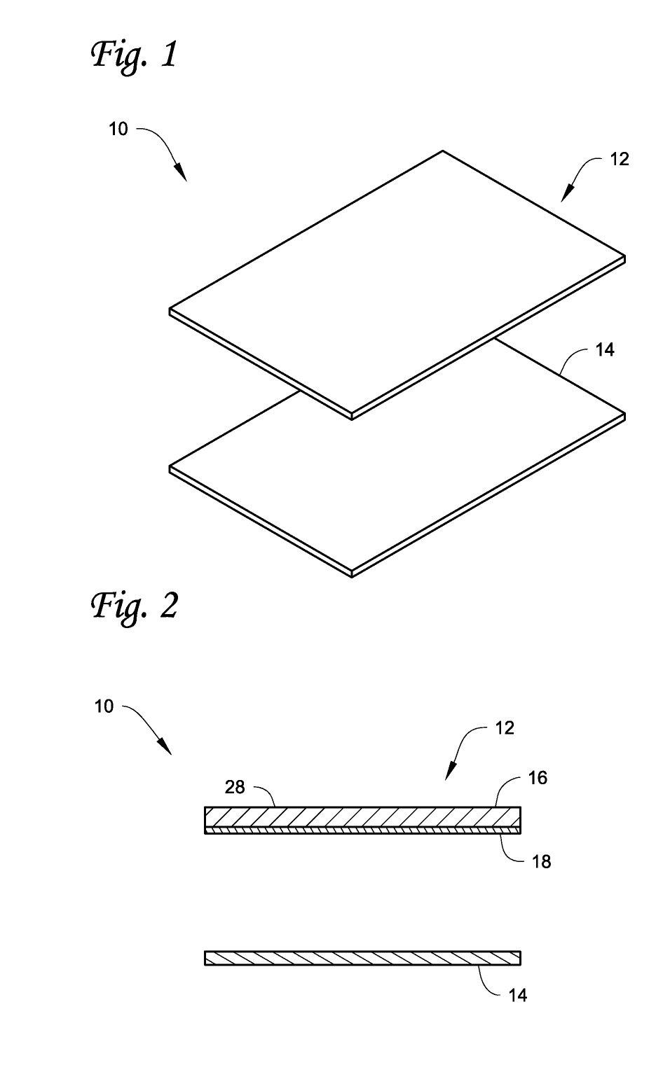

The terms “above,” “on,” “under,” “top,” “bottom,” “up,” “down,” “horizontal,” and “vertical” and the like used herein are in reference to the relative positions of the temporary tattoo removal device and its constituent parts, in use when oriented as in FIGS. 1-5. The vertical dimensions in the figures have been exaggerated for clarity.

Temporary tattoo removal devices for temporarily covering and concealing tattoos, skin lesions, scars or other marks and methods for making the same are disclosed herein. The temporary tattoo removal device includes an opaque tattoo removal device or a releasable coating layer that is configured to adhere to a user's skin to cover and conceal tattoos, skin lesions, scars or other marks. The color of the opaque tattoo removal device or releasable coating layer matches the skin tone of the user's such that the tattoo removal device or releasable coating layer is nearly invisible when applied. For sake of convenience, the tattoos, skin lesions, scars or other skin marks are collectively referred to as skin marks in the description hereunder.

With respect to FIG. 1, in one embodiment, the temporary tattoo removal device is tattoo removal device adapted to cover and conceal skin marks. The tattoo removal device 10 includes an opaque base portion 12 that matches the user's skin tone. In this application, opaque shall mean at least partially blocking the passage of light. The base portion 12 is sized and shaped to overlie the skin marks such that the skin marks are blocked and concealed. Optionally, the tattoo removal device 10 may also include a protective cover sheet 14 for covering adhesives prior to application of the tattoo removal device 10 to the user's skin. In one embodiment, the tattoo removal device 10 is used for less than a day.

The base portion 12 is very thin, having a thickness in the range of 10-100 μm and preferably in the range of 20-40 μm. In one embodiment, the base portion 12 is waterproof or water resistant such that it does not wear off in water. When in use, the base portion 12 remains on the skin for covering the skin marks. As shown in FIG. 2, the base portion 12 includes a backing layer 16 and an adhesive layer 18 coated on a bottom surface 22 of the backing layer 16.

The backing layer 16 is made of thin and flexible sheet or film material, e.g., cloth or plastic. In one embodiment, the backing layer 16 is at least partially opaque, e.g., coated with a non-toxic ink or pigment composition on a top surface 28 of the backing layer. For example, the backing layer 16 may include one or more pigments having a melanin likeness in appearance so as to substantially match the appearance of human skin. The pigment in layer 16 may be blended into the molten polymer prior to extrusion into a thin film. It is to be understood that various inks or pigments that are certified by the FDA for use in drugs and cosmetics can be used for the backing layer 16. The ink or pigment may also be included in the backing layer 16 by various methods, such as mixing in the material of the backing layer before extrusion of the backing layer, dipping, spraying, brushing, rolling and the like.

In one embodiment, the entire backing layer 16 is opaque. In an alternative embodiment, only a part of the backing layer 16 is opaque and the rest of the backing layer 16 can be clear, with or without color.

In one embodiment, the backing layer 16 can be made of a heat-fusible, nonwoven fabric material having moisture vapor permeability. The nonwoven fabric can be formed of interlaced staple or continuous textile fiber having an average length between 1 and 10 cm. The fibers are unified into a tissue by a binding agent that tends to bend the fibers at their cross-over points. Polymeric binders such as latex, particularly rubbery latex such as acrylates and urethanes, are preferred. In an alternative embodiment, the backing layer 16 can be made of woven fabric.

In one embodiment, the backing layer 16 is made of moisture permeable polyether polyurethane. The moisture permeable polyether polyurethane can further include pigment to achieve opacity and desired coloring. As such, a process for making the backing layer 16 can include pigment in the polyether polyurethane layer during extrusion. In one embodiment, a suitable pigment level is in a range between 10-20% by weight of the backing layer.

In one embodiment, the backing layer material is describable as a thin, pliable, inextensible, resilient, water-resistant tissue fabric. It is preferable that the backing layer 16 to be moisture vapor permeable at a rate of at least 1600 grams per 100 square inches of surface area per day.

With reference to FIGS. 2-4, in one embodiment, the top surface 28 of the backing layer 16 is non-reflective and does not have a shiny appearance. The texture of the backing layer 16 is similar to that of skin and is not perfectly smooth.

In another embodiment, the backing layer 16 includes a polymer that is extruded into a thin, pliable sheet. Examples of suitable materials for the backing layer 16 in this embodiment are elastomeric polyesters, polyurethane, or polyethylene.

The backing layer 16 may come in a plurality of skin tones to provide a good match with a user's skin. The plurality of colors are chosen to most closely approximate, or blend in with, the anticipated skin tones of the potential users. In one embodiment, the backing layer 16 comes in six skin tones, which match most ethnic skin tones, from very light to very dark. It is to be understood that, in one embodiment, one backing layer can include more than one color, e.g., multiple skin tones, depending on design choices. It is also to be understood that the backing layer 16 can be made entirely opaque, or alternatively, merely partially opaque with a portion being clear, with or without color.

With reference to FIGS. 2-4, the adhesive layer 18 is coated on the bottom surface 22 of the backing layer 16. In one embodiment, the adhesive layer 18 is coated on the entire surface of the bottom surface 22. In an alternative embodiment, the adhesive layer 18 is pattern coated on the bottom surface 22 to prevent decrease in moisture vapor permeability. Various methods can be used for coating the adhesive layer 18 on the backing layer 16, for example, coating the adhesive directly on the backing layer 16, or coating the adhesive on a release paper and then transferred it onto the bottom surface 22 of the backing layer 16.

The adhesive used for the adhesive layer 18 is not particularly limited if a skin is little irritated and pressure-sensitive adhesion to the skin is provided. The adhesive should exhibit sufficient adhesion, or bonding strength, to prevent peeling of the tattoo removal device from the skin prematurely, but is not so tenacious as to damage or irritate the skin during removal, especially from sensitive skin, or to leave adhesive residue on the skin, thus exhibiting acceptable shear properties. In addition, the adhesive should exhibit sufficient adhesion to the backing layer 16 to prevent unwrapping of the adhesive during wear. Examples of the adhesive include a rubbery adhesive, an acrylic adhesive, a polyurethane adhesive, a silicone adhesive and a styrene-isoprene-styrene block copolymer adhesive. In one embodiment, the adhesive layer 18 is a releasable adhesive layer.

In one embodiment, the adhesive layer 18 includes a pressure sensitive adhesive, for example, polyvinyl ethyl. In one embodiment, the adhesive layer 18 is added to the backing layer 16 at a level between 25 g/m² and 75 g/m².

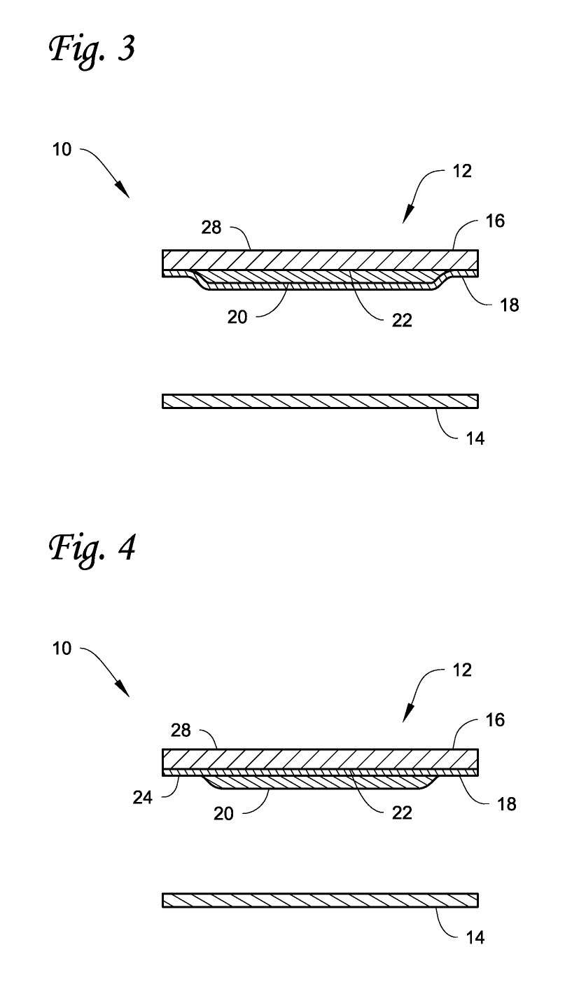

Optionally, the base portion 12 may further include an opaque blocking layer 20 that underlies a central portion of the backing layer 16 for further concealing and blocking the skin marks, as shown in FIGS. 3 and 4. As shown in FIG. 3, the blocking layer 20 is disposed over and secured to the bottom surface 22 of the backing layer 16, where the blocking layer 20 is not coterminous in size with the backing layer 16 and the peripheral of the backing layer 16 surrounding the blocking layer 20 is exposed. In one embodiment, the blocking layer 20 is secured to the backing layer 16 by heat welding the edges thereof and heat fusing the portions of the backing layer 16 extending from the blocking layer 20 to provide surfaces capable of accepting an adhesive. The blocking layer 20 can be made of various materials that act in accordance with its functional principles. In one embodiment, the blocking layer 20 is made of a heat-fusible, nonwoven fabric material which permits the blocking layer 20 to be continuously and permanently heat-welded along the edges to the backing layer 16.

With reference to FIG. 4, in one embodiment, the blocking layer 20 is disposed on the central portion of the adhesive layer 18, with no adhesive being coated on a bottom surface of the blocking layer 20. A peripheral ring 24 of the adhesive layer 18 surrounding the blocking layer 20 is exposed. This ring 24 provides the means by which the base portion 12 is affixed to the skin.

The tattoo removal device 10 is cut into different predetermined shapes which vary in style and dimension, depending upon the intended area of use upon the body, as well as upon the size of the skin marks. In one embodiment, the tattoo removal device is cut into a specific shape designed to cover specific skin marks, for example, specific, more popular tattoos.

The tattoo removal device is utilized by first selecting a tattoo removal device of appropriate skin tone, style and dimension. When selecting the skin tone, the purchaser can compare his/her skin tone, or a desired skin tone, to the plurality of skin colors of the tattoo removal device 10 and select the matching color. Before the tattoo removal device is applied to the skin, the protective cover sheet 14 is removed from the tattoo removal device 10 to expose the adhesive. When the tattoo removal device 10 is in a tape form, the top surface 28 of the tattoo removal device can be used as the protective sheet for the portion of the tape wrapping thereon. See Table below including examples of styles, dimensions, packaging and skin tones of the tattoo removal device 10.

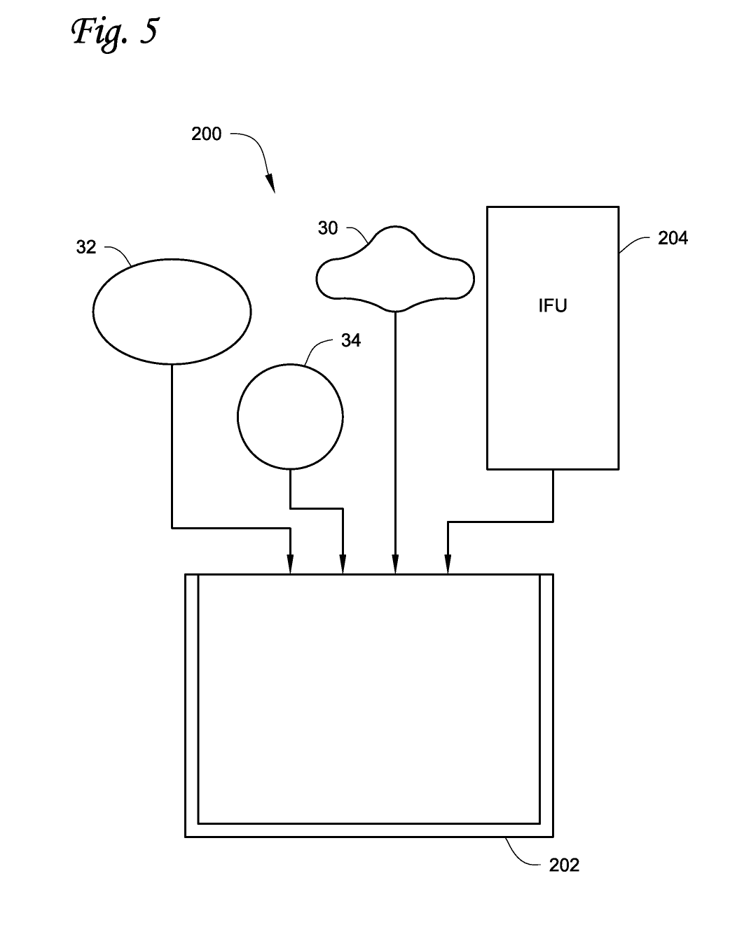

TABLE
Example of styles, dimensions, packaging methods
and skin tones of the tattoo removal device

| Example of | Example of | Example of | Example of |
|---|---|---|---|
| styles | dimensions | packaging methods | skin tones |
| Tape | Approximately ½ | Manufactured and | Skin tone #1 |
| | inch wide by <.05 mm thick | packaged so customer | Skin tone #2 |
| | | can cut the tape to the | |
| | | appropriate size to | |
| | | adhere to tattoos of | |
| | | multiple sizes and shapes | |
| | | and to be applied to any | |
| | | area of the body | |
| patches | Various shapes and sizes, including | Manufactured and | Skin tone #3 |
| | circular patch, elliptical patch, | packaged in a pre-cut | Skin tone #4 |
| | square patch, rectangular patch, etc, | size/shape to specifically | |
| | For example, the circular patch 34 | adhere and cover a tattoo | |
| | and the elliptical patch 30 as shown | anywhere on the body | |
| | in FIG. 5. The size of the patch can | | |
| | be, for example, approximately | | |
| | 2″ × 2″, 3″ × 3″, 4″ × 4″, 5″ × 5″, etc. | | |
| Lower | Various shapes suitable for | Manufactured and | Skin tone #5 |
| back | covering a tattoo on a lower back. | packaged in a pre-cut | Skin tone #6 |
| patches | For example, the lower back patch | size/shape to specifically | |
| | 30 as shown in FIG. 5, with | adhere and cover lower | |
| | approximately 7-8 inches across, 1-2 | back tattoos | |
| | inches wide at ends and | | |
| | approximately 2-4 inches in the | | |
| | middle | | |

After the exposed adhesive surface of the base portion 12 is applied to the skin at a predetermined location, pressure is applied to promote adhesion between the base portion 12 and the skin. Because the base portion 10 is thin, and because its color matches the user's skin tone, it is nearly invisible when applied. The base portion 12 may be made less detectable by concealing the base portion 12 with cosmetic preparations, if desired.

With reference to FIG. 5, a kit 200 that is adapted for covering or concealing the skin marks is disclosed herein. The kit 200 may include a packaging 202, one or more segments of temporary tattoo removal devices that are adapted to be affixed to a user's skin, and instructions for use (IFU) 204 setting forth a method for applying the temporary tattoo removal device to the skin according to the present disclosure. It is to be understood that when a plurality of temporary tattoo removal devices are included in the kit 200, they can include various styles of, for example, tattoo removal device 10. For example, the tattoo removal device 10 of the same skin tone but various styles and dimensions or even in a tape form can be placed in a package for use. Also, the segments may be of various precut sizes and shapes or be of one size that may be cut to the desired size and shape. Thus, the user may use various combinations of the temporary tattoo removal devices, for example, various types, sizes and shapes as desired. Instructions for use (IFU) 204 can be printed on a separate sheet of paper in the form of a package insert, but could also be printed partly or wholly on the packaging itself. With reference to FIG. 5, the various styles included in the kit 200 include a circular patch 34, an elliptical patch 32 and a lower back patch 30.

The described embodiments are to be considered in all respects only as illustrative and not restrictive. The scope of the invention is therefore, indicated by the appended claims rather than by the foregoing description. All changes which come within the meaning and range of equivalency of the claims are to be embraced within their scope.

1. A method for removing a tattoo, comprising:
comparing a desired skin tone with a plurality of colors available for a tattoo removal device;
selecting a matching color from the plurality of colors available for the tattoo removal device;
selecting a style of the tattoo removal device based on a shape of the tattoo to be covered;
determining a dimension of the tattoo removal device based on a size of the tattoo to be covered;
obtaining the tattoo removal device with the selected color, style and dimension, the tattoo removal device being at least partially opaque;
removing a protective cover sheet to expose a base portion including a backing layer and an adhesive layer;
overlaying the tattoo with the tattoo removal device to conceal the tattoo, with the adhesive layer positioned to contact user's skin, such that the base portion is substantially indistinguishable from the user's skin; and
applying pressure on the base portion toward the user's skin at a location corresponding to the adhesive layer such that the base portion adheres to the user's skin.

2. The method for removing a tattoo of claim 1, wherein the backing layer is made of moisture permeable polyether polyurethane.

3. The method for removing a tattoo of claim 1, wherein the adhesive layer covers merely partially a backing layer of the tattoo removal device.

4. The method for removing a tattoo of claim 1, further including concealing the base portion with cosmetic preparation.

5. The method for removing a tattoo of claim 1, wherein the tattoo removal device is in a tape form.

6. The method for removing a tattoo of claim 5, wherein a surface of the base portion forms the protective cover sheet of a portion of the tattoo removal device that wraps thereon.

7. The method for removing a tattoo of claim 1, wherein a thickness of the base portion is in the range of 20-40 μm.

8. A tattoo removal device, comprising:
a base portion including an opaque backing layer, the backing layer having a first major surface and a second major surface, the base portion further including an adhesive layer attached to the first major surface of the backing layer; and
a protective coversheet,
wherein the base portion is substantially indistinguishable from a desired skin tone.

9. The tattoo removal device of claim 8, further including a blocking layer adapted to at least partially block passage of light.

10. The tattoo removal device of claim 8, wherein the backing layer is made of moisture permeable polyether polyurethane.

10. The tattoo removal device of claim 8, wherein the adhesive layer covers partially the backing layer.

11. The tattoo removal device of claim 8, further including cosmetic preparation adapted to conceal the base portion.

12. The method for removing a tattoo of claim 1, wherein a style of the tattoo removal device is selected from the group consisting of a circular patch, an elliptical patch, a square patch, a rectangular patch, a lower back patch, an irregularly-shaped patch and a tape.

13. The tattoo removal device of claim 8, wherein a surface of the base portion forms the protective cover sheet of a portion of the tattoo removal device that wraps thereon.

14. The tattoo removal device of claim 8, wherein a thickness of the base portion is in a range of 20-40 μm.

15. The tattoo removal device of claim 8, wherein the entire backing layer is opaque.

16. A tattoo removal device kit, comprising:
a plurality of tattoo removal devices, each including:
a base portion including an opaque backing layer, the backing layer having a first major surface and a second major surface, the base portion further including an adhesive layer attached to the first major surface of the backing layer; and
a protective coversheet,
wherein the base portion is substantially indistinguishable from a desired skin tone;
instructions for use of the tattoo removal devices; and
a packaging for containing the plurality of tattoo removal devices and the protective cover sheet,
wherein styles of the tattoo removal devices include at least one selected from the group consisting of a circular patch, an elliptical patch, a square patch, a rectangular patch, a lower back patch, an irregularly-shaped patch and a tape.
